(19) United States
(12) Patent Application Publication
(10) Pub. No.: US 2016/0233944 A1
(43) Pub. Date: Aug. 11, 2016

(54) Rule Based Switchable Polarization

(71) Applicant: CommScope Technologies LLC, Hickory, NC (US)

(72) Inventor: Venkatesh Viswanathan, Lewisville, TX (US)

(21) Appl. No.: 15/012,002

(22) Filed: Feb. 1, 2016

Related U.S. Application Data
(60) Provisional application No. 62/113,776, filed on Feb. 9, 2015.

(51) Int. Cl. H04B 7/10; H04B 17/309; H04L 12/26; H01Q 3/24

(52) U.S. Cl. CPC H04B 7/10; H01Q 3/24; H04B 17/309; H04L 43/16; H04L 43/0823

(57) ABSTRACT

Aspects of the present disclosure are directed to rule based switchable polarization techniques. In one aspect, a device may receive one or more RF signals. A packet error rate associated with the received one or more RF signals may be determined. A polarization switching circuit may determine if the measured PER is greater than a predetermined threshold PER. In response to the determination that the PER is greater than the predetermined threshold PER, the polarization switching circuit may change a polarization of the device.

### CROSS-REFERENCE TO RELATED APPLICATION

The present application claims priority under 35 U.S.C. 119 to U.S. Provisional Application Ser. No. 62/113,776, filed Feb. 9, 2015, the entire content of which is incorporated herein by reference.

### BACKGROUND

Aspects of the disclosure relate to wireless communication systems, and, more particularly, to apparatus and methods for switching a polarization of a device based on one or more rules.

In wireless communication systems, there is an ever-increasing demand for higher data throughput and reduced interference. In certain frequency bands of operation, such as the Industrial, Scientific, Medical (ISM) bands, 5 GHz, and 60 GHz frequency bands, there exists a high susceptibility to interference from other access points, stations, radio transmitting devices, objects, and/or to changes or disturbances in the wireless link environment. This interference may degrade a wireless link by, for example, causing a polarization of electromagnetic waves to change, contributing to increased packet loss, especially in dense environments.

### SUMMARY

Aspects of the present disclosure are directed to rule based switchable polarization techniques. In one aspect, a device such as a transceiver may receive one or more radio frequency (RF) signals. A packet error rate (PER) associated with the received RF signals (or other indicator of link quality) may be measured or otherwise determined A polarization switching circuit may be provided that is used determine, for example, if the measured PER is greater than a predetermined threshold PER. In response to the determination that the PER is greater than the predetermined threshold PER, the polarization switching circuit may change a polarization of the device.

### BRIEF DESCRIPTION OF THE DRAWINGS

FIG. 1 is a block diagram of a transceiver having a polarization switching circuit according to an aspect of the present disclosure;

FIG. 2 is flow chart illustrating a method for switching a polarization of a device according to an aspect of the present disclosure; and

FIGS. 3-6 are exemplary environments employing one or more polarization switching circuits according to aspects of the present disclosure.

### DETAILED DESCRIPTION

Certain terminology is used in the following description for convenience only and is not limiting. The words “lower,” “bottom,” “upper” and “top” designate directions in the drawings to which reference is made. Unless specifically set forth herein, the terms “a,” “an” and “the” are not limited to one element, but instead should be read as meaning “at least one.” The terminology includes the words noted above, derivatives thereof and words of similar import. It should also be understood that the terms “about,” “approximately,” “generally,” “substantially” and like terms, used herein when referring to a dimension or characteristic of a component, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

Polarization is an important factor for radio frequency (RF) antennae and wireless communications in general. Both RF antennae and electromagnetic waves are said to have a polarization. The polarization of an electromagnetic wave may generally be described as the plane in which the electromagnetic wave vibrates. Because RF antennae may be sensitive to polarization, RF antennae may more effectively receive and transmit signals that have a particular polarization. In many cases, a polarization of an RF antenna may be in the same plane as the radiating elements of the antenna. For example, a vertical antenna (e.g., an antenna with radiating elements that are arranged vertically) may more effectively receive vertically polarized signals, and a horizontal antenna (e.g., one with radiating elements that are arranged horizontally) may more effectively receive horizontally polarized signals. Between horizontal and vertical polarizations, there is a 90 degree range that may be leveraged in the presence of interference using the same channel.

Other techniques, such as those used with MIMO architectures, may employ a combination of multiple channels, signal-processing algorithms, and antennas to achieve higher throughput and to decrease bit error rates (BER). Employing these combinations comes at a cost of increased complexity and expense. Further, circular polarization techniques exhibit a 3 dB loss as power is split across two separate planes compared to linear polarization techniques. As such, aspects of the present disclosure may be advantageous at least because aspects described herein may be performed mainly by the RF and antenna portions, resulting in processing simplifications.

Aspects of the present disclosure are directed to a packet error rate (PER) rule based electronically switchable polarization device for wireless transceivers. In light of the disclosure, those of skill in the art may appreciate advantages to be had if a transceiver could quickly switch a phased array antenna from operation in one polarization mode to operation in another, different polarization mode, or varying degrees there between. For example, it may be desirable for a phased array to be capable of switching to any one of several different polarizations (e.g., linear vertical, linear horizontal, right-hand circular, left-hand circular, and the like). As an example, in a particular environment, one wireless device may wish to wirelessly communicate information with another wireless device. One or more objects (e.g., obstructions) may introduce a multipath effect causing a polarization of electromagnetic waves (used to carry the desired information) to change. According to aspects of the disclosure, the wireless device designated to receive the information may include a polarization switching circuit that can alter the polarization at which the receiving device receives the signals carrying the information. By switching the polarization, for example by changing the phase and/or gain of radiating elements of a phased array antenna, the receiving wireless device may reduce the PER of the signals it is attempting to receive.

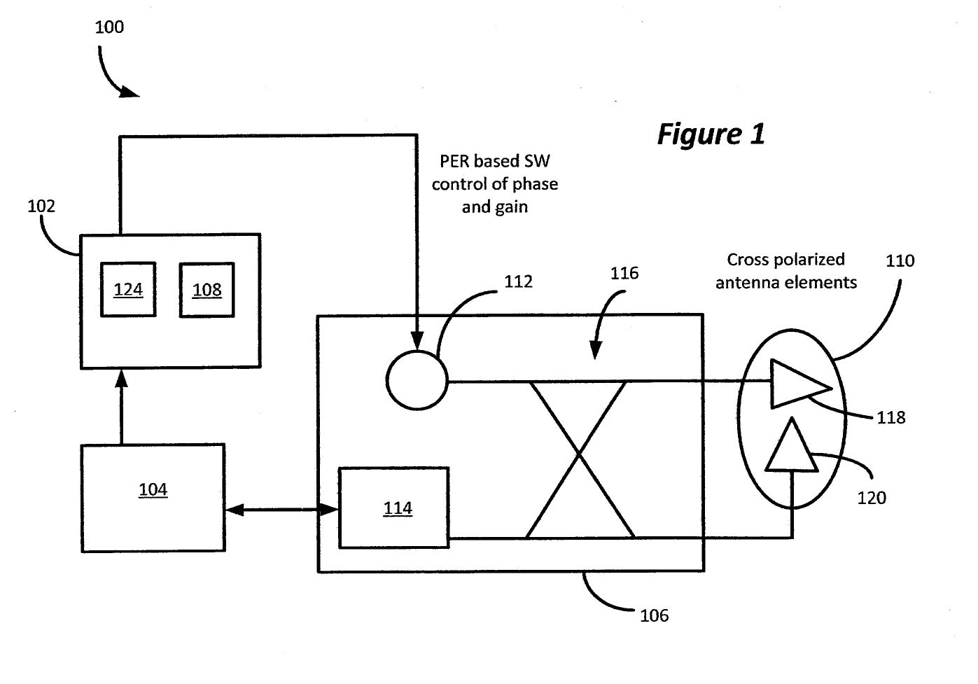

As such, according to aspects of the present disclosure, the polarization of an antenna of a wireless transceiver may be adjusted so that a communications link may be maintained with an acceptable PER. FIG. 1 is a schematic diagram of a wireless transceiver 100 that includes a polarization switching circuit 102 according to an aspect of the disclosure. The wireless transceiver 100 may include an RF/baseband processor 104, a transceiver sub-circuit 106, the polarization switching circuit 102, and an antenna 110. An output of the RF/baseband processor 104 may be coupled to an input of the polarization switching circuit 102. An output of the polarization switching circuit 102 may be coupled to an input of the transceiver sub-circuit 106. The transceiver sub-circuit 106 may include one or more tunable phase shifters/gain controllers 112, one or more combiner/splitters 114, and a 90 degree hybrid coupler 116. The 90 degree hybrid coupler 116 may be cascaded with the antenna 110. The antenna 110 may take the form of a dual-polarized radiator element having two feed ports 118, 120, each of which may excite an orthogonal polarization component. The dual-polarized radiator element may comprise an array of radiating elements, such as a phased array of radiating elements as discussed above. Examples of such radiators may include, but are not limited to, crossed dipoles, orthogonally fed square waveguides and dual-polarized microstrip patches. Due at least in part to the fact that passive intermodulation (PIM) may be negligible in some frequency bands of operation, such as the ISM, 5 GHz, and 60 GHz bands, the one or more tunable phase shifters/gain controllers 112 may include one or more liquid crystal and/or complementary metal oxide semiconductor (CMOS) phase shifters as known in the art.

The transmit or received signals may be weighed with different phases or different magnitudes using the tunable phase shifter/gain controllers 112. For example, by applying a determined phase and current to one of both of the first feed port 118 and the second feed port 120, the polarization of antenna 110 may be excited in desired direction.

It should be noted that the above described wireless transceiver 100 may be capable of any type of polarization, or any degree thereof, known in the art, and not limited to those discussed above.

The RF/baseband processor 104 may process communication signals. For example, during reception, the RF baseband processor 104 may receive combined signals from the antenna 110 via the transceiver sub-circuit 106, perform down-conversion, demodulation, decoding, and any other known processes to extract information or data conveyed in the received combined signals. On the transmit side, the RF baseband processor 104 may receive data, which may represent voice, data, or control information from a network interface (not shown) and perform encoding, modulation, amplification, up-conversion, and any other known process for transmission of the RF signals through the antenna 110 via the transceiver sub-circuit 106. The RF/baseband processor 104 may generally be implemented in one or more digital signal processors (DSPs) and/or application specific integrated circuits (ASICs).

The polarization switching circuit 102 may include a memory 108 and a polarization switching module 124. The memory 108 may include gain and phase information in the form of, for example, a table, and may be realized, for example, as RAM memory, flash memory, EPROM memory, EEPROM memory, registers, a hard disk, a removable disk, or any other form of storage medium known in the art. The gain and phase information may include gain and phase settings for desired polarizations. The memory 108 may also include acceptable signal quality characteristics which may include, but are limited to, packet error rate (PER) threshold information. For example, threshold information may represent a ratio at which the PER is deemed to be unacceptable. As another example, the threshold information may represent an unacceptable percentage of packets successfully received by the wireless transceiver 100, such as a percentage representing a percentage deemed unacceptable by the wireless transceiver 100. Alternatively, the threshold information may represent a ratio at which the PER is deemed to be acceptable. As another example, the threshold information may represent an acceptable percentage of packets successfully received by the wireless transceiver 100, such as a percentage deemed to be acceptable by the wireless transceiver 100.

It should be noted that the wireless transceiver 100 may be configured to use any wireless communication scheme known to those skilled in the art, including long range and short range communication protocols such as ZIGBEE, IEEE 802.11 Wi-Fi, BLUETOOTH, infrared and the like.

The polarization switching module 124 may query the RF/baseband processor 104, determine whether received signals are of an acceptable quality (e.g., based on the PER), and switch a polarization mode of the wireless transceiver 100 through control of the phase and/or gain of the transceiver sub-circuit 106 if the received signals are not of acceptable quality.

The polarization switching circuit 102 may also include a display (not shown) which may be in the form of a touch-screen display, such that a user can input certain settings or configurations (such as the above described phase/gain settings and PER threshold information) for operation of the polarization switching circuit 102 and/or the wireless transceiver 100.

As shown, the polarization switching circuit 102 is separate from the RF/baseband processor 104. However, it should be noted that the polarization switching circuit 102 may be realized as a part of the RF/baseband processor 104.

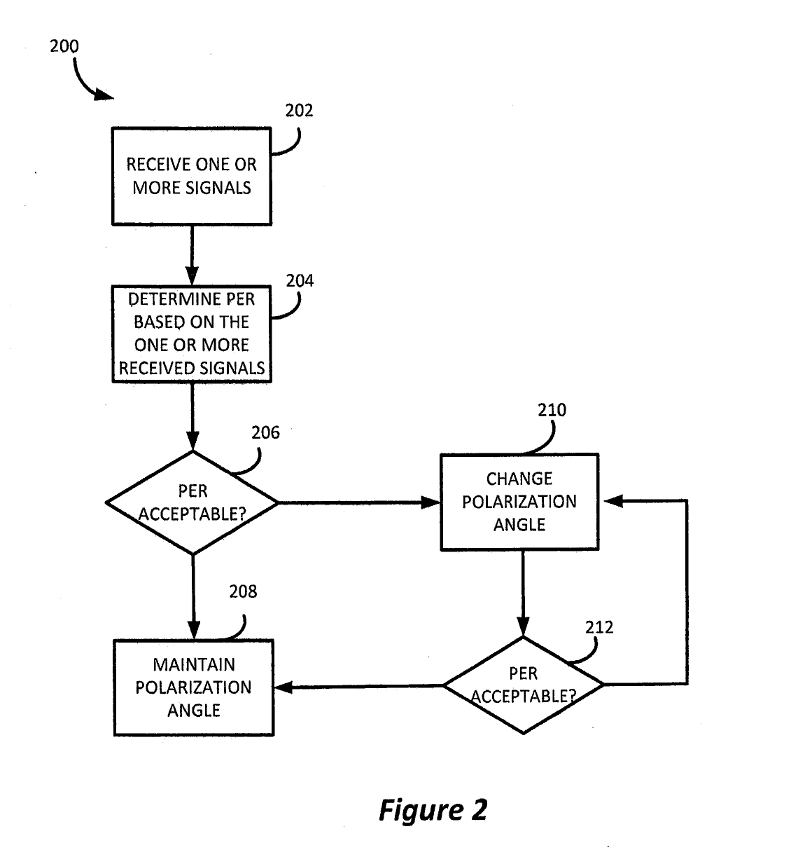

FIG. 2 is a flowchart illustrating a method for setting a polarization of an antenna 110 to reduce a PER of signals in a wireless environment. At block 202, a signal may be received by the antenna 110. At block 204, a PER for the received signal may be determined and, at block 206, the PER may be compared to an acceptable PER. The acceptable PER may be a predetermined number, ratio or the like. If the determined PER is acceptable (e.g., lower than a threshold PER), at block 208, a polarization angle of the antenna 110 may be maintained. If the determined PER is outside a preferred range (e.g., greater than the threshold PER), at block 210, a polarization angle of the antenna 110 may be changed by a predetermined number of degrees θ. For example, if the polarization was vertical, it may be changed by 15 degrees through tuning of the phase shifter/gain controllers 112 as described above. At block 212, the PER may be checked again to determine if it is acceptable. If acceptable, the polarization angle may be maintained. Otherwise, the polarization angle may be changed by a predetermined number of degrees θ at block 212. The method may continue until a satisfactory PER is achieved and maintained. The method may monitor the PER for any changes while the wireless communications link is maintained, and change the angle of polarization as needed as described above. The variable number of degrees θ may be as large or small as desired, and may change during operation of the wireless transceiver 100, for example, to become smaller as the PER improves in order to fine tune the reception.

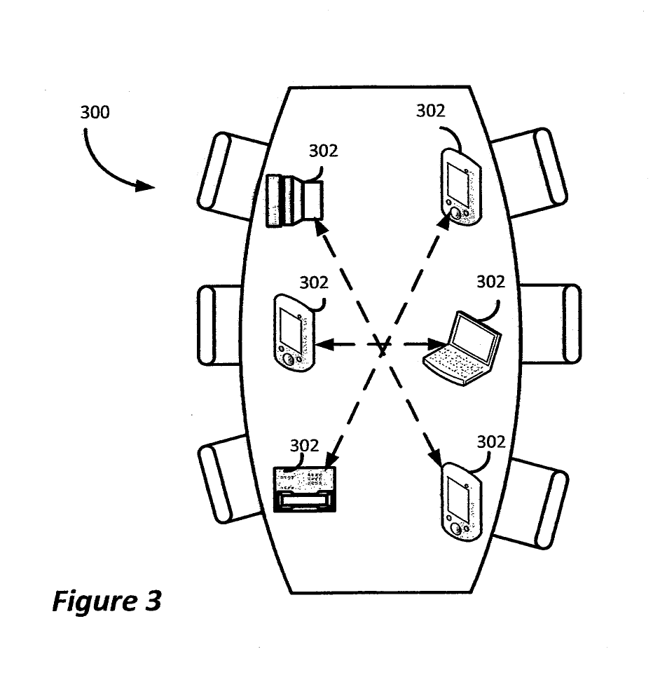

FIG. 3 is an environment (e.g., a conference room) 300 in which the polarization switching circuit 102 may be used. The conference room environment 300 may include one or more wireless devices 302, one or more of which may include the polarization switching circuit 102. In some aspects, one or more of the wireless devices 302 may be configured to communicate with other wireless devices and may be referred to as device-to-device (“D2D”) communication devices. A D2D communication device may include a mobile station, as defined by Institute for Electrical and Electronic Engineers (“IEEE”) 802.16e (2005), 802.16m (2009), or subsequent revisions, releases, or updates thereto, or user equipment, as defined by the 3^{rd} Generation Partnership Project (“3GPP”) Long Term Evolution (“LTE”) Release 8, Release 9, Release 10, Release 11, Release 12 or subsequent revisions, releases, or updates thereto. The switchable polarization circuit 102 may be implemented in a transmitter, receiver, or both (e.g., transceiver) as a part of wireless device so as to improve the PER of communication signals among users in a conference room or other environment, potentially enabling more users to simultaneously access the same channel.

Any communication network or environments described herein may provide for communications in accordance with any wired or wireless communication standard. For example, the communication network can provide for communications in accordance with second-generation (2G) wireless communication protocols IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, fifth-generation (5G) wireless communication protocols, or the like.

Further, such described networks may be configured to provide for communications in accordance with techniques such as, for example, radio frequency (RF), infrared, or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth™, ultra wideband (UWB) and/or the like.

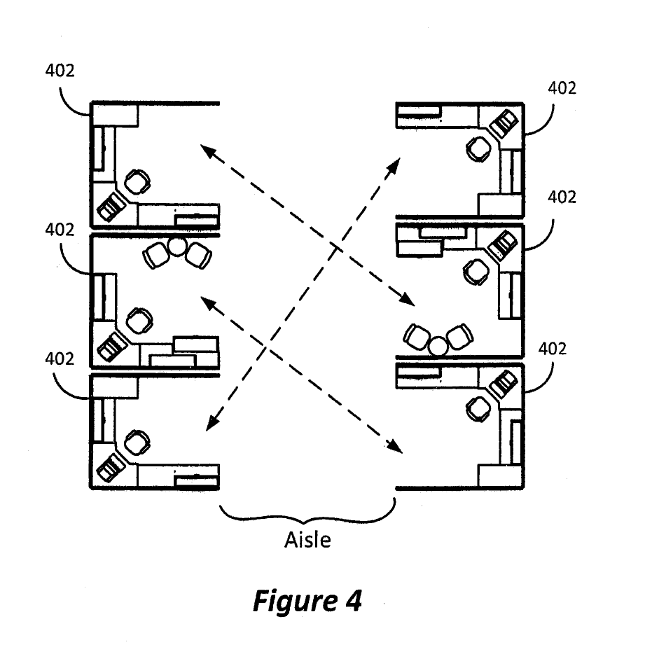

Referring to FIG. 4, multiple users may communicate using the same channel using the same modulation, but with different polarization to their respective offices 402, for example, in an office setting.

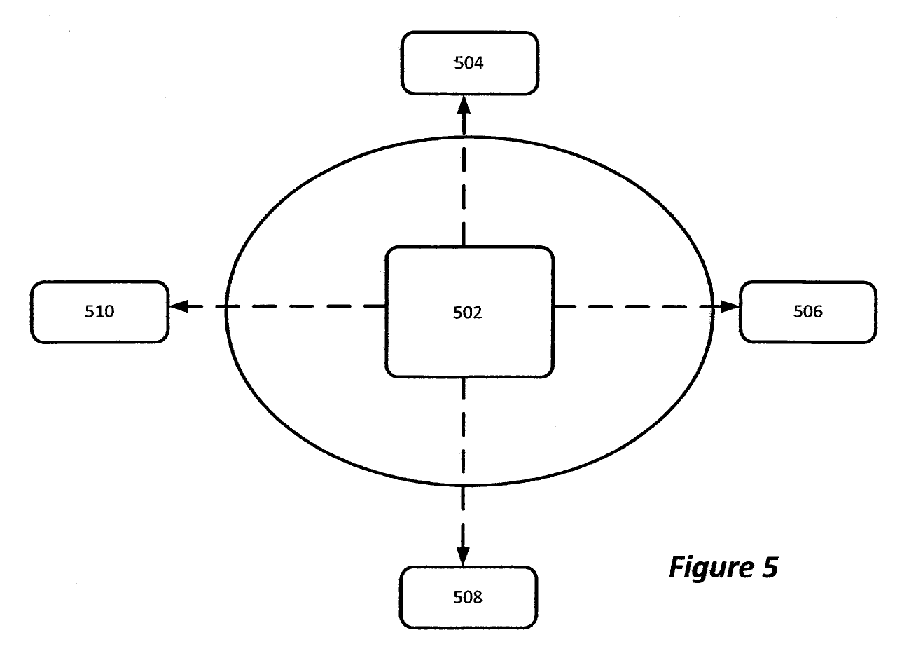

Referring now to FIG. 5, one or more devices, such as a coordinating device 502 (e.g., a device including a transmitter) may assign different polarization modes for use by respective devices 504, 506, 508, 510 as new devices are added using the same channel. For example, users (e.g., devices) may dynamically switch their respective polarization in the same channel with low packet loss. For example, the coordinating device 502 may determine which polarization direction to select to match the polarization of any of the connecting devices 504, 506, 508, 510. Such selection may be performed through a handshaking process with one or more of the connecting devices 504, 506, 508, 510. Such an implementation may be particularly beneficial in dense outdoor or indoor environments such as shopping malls.

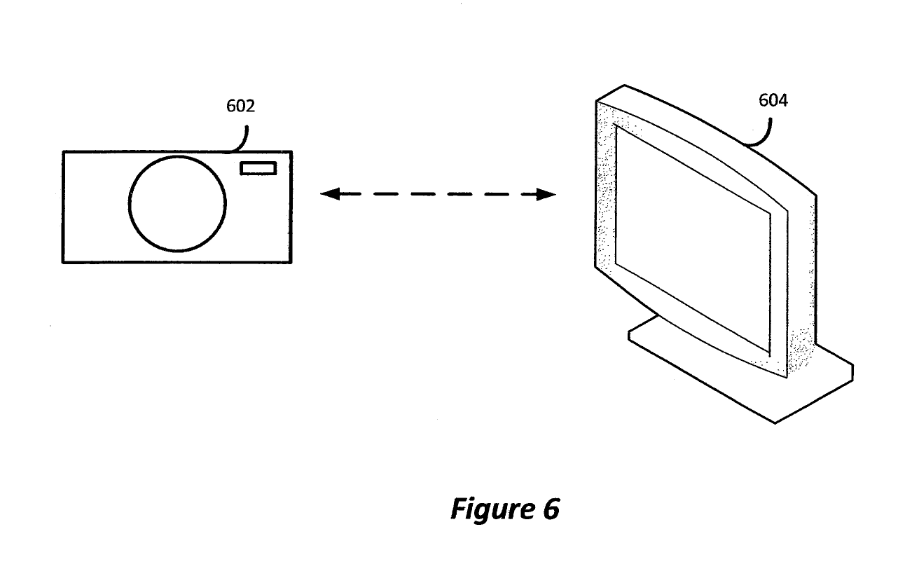

Referring to FIG. 6, another example environment including a network operating at 60 GHz may employ a polarization switching circuit. For example, the polarization switching circuit may be implemented into one or more devices such as a camera, or other device 602 which may transfer raw uncompressed data to another device 604 (e.g., receiver, TV, toy, or the like) at 60 GHz with decreased packet loss due, at least in part, to the ability of one or more of the devices 602, 604 to switch its polarization using the above discussed polarization switching circuit.

It should be noted that the above discussed environments are by non-limiting example only. Other environments and networks may be contemplated in keeping with the spirit of the present disclosure.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative blocks described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Various embodiments of the invention have now been discussed in detail; however, the invention should not be understood as being limited to these embodiments. It should also be appreciated that various modifications, adaptations, and alternative embodiments thereof may be made within the scope and spirit of the present invention.

That which is claimed is:

1. A method of operating a wireless transceiver that receives signals through an associated antenna, the method comprising:
determining signal quality information for data received at the wireless transceiver;
comparing the signal quality information to stored information to determine if the received signal quality is below a pre-selected threshold; and
adjusting a polarization angle in response to a determination that the received signal quality is below the pre-selected threshold.

2. The method of claim 1, wherein adjusting the polarization angle in response to a determination that the received signal quality is below the pre-selected threshold comprises adjusting a polarization angle a preselected number of degrees.

3. The method of claim 1, wherein adjusting the polarization angle in response to a determination that the received signal quality is below the pre-selected threshold comprises adjusting a polarization angle by less than 60 degrees.

4. The method of claim 1, wherein adjusting the polarization angle in response to a determination that the received signal quality is below the pre-selected threshold comprises adjusting a polarization angle by less than 45 degrees.

5. The method of claim 1, wherein adjusting the polarization angle in response to a determination that the received signal quality is below the pre-selected threshold comprises adjusting a polarization angle by adjusting at least one of a phase or a gain along a signal path to at least one radiating element of the antenna.

6. The method of claim 1, wherein comparing the signal quality information to stored information to determine if the received signal quality is below the pre-selected threshold comprises comparing an error rate for the received data to a pre-selected threshold error rate.

7. The method of claim 6, wherein the error rate comprises a packet error rate.

8. The method of claim 7, wherein the packet error rate comprises a first packet error rate and the adjustment to the polarization angle comprises a first adjustment of the polarization angle, the method further comprising:
determining a second packet error rate for data received at the wireless transceiver after the polarization angle has been adjusted;
comparing the second packet error rate to the stored information to determine if the second packet error rate is below the pre-selected threshold; and
performing a second adjustment to the polarization angle in response to a determination that the packet error rate is below the pre-selected threshold.

9. The method of claim 8, wherein the first adjustment to the polarization angle adjusts the polarization angle more than the second adjustment to the polarization angle.

10. A wireless transceiver, comprising:
a baseband processor;
a transceiver sub-circuit that is coupled to an output of the baseband processor, the transceiver circuit including a tunable phase shifter;
an antenna having a dual-polarized radiating element; and
a polarization switching circuit that is configured control the tunable phase shifter in response to signal quality information that is input to the polarization switching circuit from the baseband processor to adjust a polarization angle of the antenna.

11. The wireless transceiver of claim 10, wherein the signal quality information comprises a packet error rate.

12. The wireless transceiver of claim 11, wherein the polarization switching circuit includes a memory that has a pre-selected signal quality threshold stored therein.

13. The wireless transceiver of claim 12, wherein the tunable phase shifter is a tunable phase shifter/gain controller, and wherein the memory further includes gain and phase settings for the tunable phase shifter/gain controller that provide pre-selected polarization changes.

14. The wireless transceiver of claim 10, wherein the antenna comprises a phased array antenna that includes a plurality of dual-polarized radiating elements.

15. The wireless transceiver of claim 10, wherein the polarization switching circuit is configured to change the polarization by a pre-selected number of degrees in response to a determination that the signal quality information falls outside a pre-selected range.

16. The wireless transceiver of claim 15, wherein the pre-selected number of degrees is less than 60 degrees.

17. The wireless transceiver of claim 15, wherein the polarization switching circuit is further configured to fine tune the polarization by changing the polarization angle of the antenna by smaller amounts.

18. A method for switching a polarization of a device, the method comprising:
receiving one or more radio frequency (RF) signals;
measuring a packet error rate (PER) associated with the received one or more RF signals;
determining if the PER is greater than a threshold PER; and
in response to determining that the PER is greater than the threshold PER, changing a polarization of the device.

19. The method of claim 18, wherein the change in the polarization of the device comprises an adjustment of the polarization angle by less than 60 degrees.

20. The method of claim 18, wherein changing the polarization of the device comprises adjusting at least one of a phase or a gain along a signal path from a radiating element of an antenna of the device.
